(19) United States
(12) Patent Application Publication
(10) Pub. No.: US 2014/0279814 A1
(43) Pub. Date: Sep. 18, 2014

(54) CONTEXT-AWARE METHOD AND APPARATUS

(71) Applicant: SAMSUNG ELECTRONICS CO., LTD., Suwon-si (KR)

(72) Inventors: Sang-Do PARK, Seoul (KR); Hee-Youl CHOI, Hwaseong-si (KR)

(73) Assignee: SAMSUNG ELECTRONICS CO., LTD., Suwon-si (KR)

(21) Appl. No.: 14/198,512

(22) Filed: Mar. 5, 2014

(30) Foreign Application Priority Data
Mar. 14, 2013 (KR) 10-2013-0027437

(51) Int. Cl. G06N 5/04

(52) U.S. Cl. CPC G06N 5/048
USPC 706/52

(57) ABSTRACT

A context-aware apparatus and a context-aware method are provided. The context-aware apparatus includes a context-model creating unit configured to create a context model based on input data; and a context reasoning unit configured to update a previously stored context model in a memory storage based on the created context model, and to infer a context using the updated context model and input data.

### CROSS-REFERENCE TO RELATED APPLICATION

This application claims the benefit under 35 USC 119(a) of Korean Patent Application No. 10-2013-0027437 filed on Mar. 14, 2013, in the Korean Intellectual Property Office, the entire disclosure of which is incorporated herein by reference for all purposes.

### BACKGROUND

1. Field

The following description relates to context-aware technologies, and to a context-aware apparatus and a context-aware method using a combination of deductive reasoning and inductive reasoning.

2. Description of Related Art

Context awareness refers to technologies for detecting changes in context of a device, and providing information or services suitable for a user of the device or changing a state of a system by the system itself. Context awareness is implemented by applying a context model for reasoning the context.

As methods of inferring the context, a deductive reasoning method and an inductive reasoning method may be used. In a deductive reasoning method, domain experts describe accumulated experience or rules for specific situations in advance to create a context model and carries out reasoning based on the created context model. In an inductive reasoning method, generalized conclusions or general principles may be derived from findings obtained by observing and measuring specific empirical phenomena and reasoning based on the derived conclusions or principles may be carried out.

A conventional context-aware system uses the deductive reasoning method in which the domain experts create the context model to carry out reasoning.

However, in the deductive reasoning method, there are difficulties in describing all situations by experts, and it is impossible to carry out reasoning when modeling is difficult to be performed such as in big data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a context-aware apparatus is provided, the context-aware apparatus including: a context-model creating unit configured to create a context model based on input data; and a context reasoning unit configured to update a previously stored context model in a memory storage based on the created context model, and to infer a context using the updated context model and the input data.

The previously stored context model may include a key-value model, a markup scheme model, an object oriented model, a logic-based model, or an ontology-based model.

The context-model creating unit may include a learning unit configured to learn the input data, and a conversion unit configured to convert learning outcomes of the learning unit into the context model by expressing the learning outcomes in a preset language.

The learning unit may be configured to mechanically learn the input data for a preset learning period.

The preset language may include a resource description framework (RDF), a web ontology language (OWL), N3, a rule markup language (RuleML), a semantic web rule language (SWRL), or a prolog.

The context-aware apparatus may further include a context-model input unit configured to receive the context model from outside.

The context-aware apparatus may be a mobile device capable of wireless communication or network communication, and the context-aware apparatus may be configured to obtain the input data from at least one of a proximity sensor, a microphone, a motion sensor, an illuminance sensor, a gyro sensor, an acceleration sensor, a temperature sensor, and a pressure sensor of the mobile device.

In another general aspect, there is provided a context-aware method, the method involving: creating a context model based on input data; updating a previously stored context model in a memory storage based on the created context model; and inferring a context using the input data and the updated context model.

The previously stored context model may include a key-value model, a markup scheme model, an object oriented model, a logic-based model, or an ontology-based model.

The creating of the context model may involve learning the input data, and converting learning outcomes of the learning of the input data into the context model by expressing the learning outcomes.

The learning of the input data may include mechanically learning the input data for a preset learning period.

The preset language may include RDF, OWL, N3, RuleML, SWRL, or a prolog.

In another general aspect, there is provided a non-transitory computer-readable medium storing instructions that cause a computer to perform the above method.

In another general aspect, there is provided a context-aware apparatus involving: a context-model input unit configured to receive a context model from outside, the context model being based on learning of input data for a preset learning period; and a context reasoning unit configured to update a previously stored context model in a memory storage based on the received context model, and to infer a context using the updated context model and the input data.

The input data may be obtained from a sensor comprising at least one of a proximity sensor, a microphone, a motion sensor, an illuminance sensor, a gyro sensor, an acceleration sensor, a temperature sensor, and a pressure sensor of a mobile device.

Other features and aspects will be apparent from the following detailed description, the drawings, and the claims.

### BRIEF DESCRIPTION OF THE DRAWINGS

FIG. 1 is a diagram illustrating an example of a context-aware apparatus.

FIGS. 2A and 2B are diagrams illustrating an example of a process of updating a context model by using the context-aware apparatus of FIG. 1.

FIGS. 3A and 3B are diagrams illustrating an example of a context model created by a context-model creating unit of FIG. 1.

FIG. 4 is a diagram illustrating an example in which a context-aware apparatus of FIG. 1 is applied to a terminal.

FIG. 5 is a diagram illustrating another example in which a context-aware apparatus of FIG. 1 is applied to a terminal.

FIG. 6 is a flowchart illustrating an example of a context-aware method according to the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

FIG. 1 is a diagram illustrating an example of a context-aware apparatus 100.

Referring to FIG. 1, the context-aware apparatus 100 according to one embodiment includes a context-model creating unit 110 and a context reasoning unit 120.

The context-model creating unit 110 may create a context model based on input data. For this, the context-model creating unit 110 may include a learning unit 111 and a conversion unit 112.

The learning unit 111 may learn the input data. In this instance, the input data may include sensing data collected from at least one sensor or external data of the context-aware apparatus. Here, the sensor may include a GPS module, a proximity sensor, a motion sensor, an illuminance sensor, a gyro sensor, an acceleration sensor, a temperature sensor, a pressure sensor, and the like. The external data of the context-aware apparatus may include SNS data, linked data, web data, and the like.

The learning unit 111 may learn the input data for a preset learning period. For example, as a learning method, a machine learning algorithm may be used. The machine learning algorithm may include an artificial neural network, a decision tree, a genetic algorithm (GA), genetic programming (GP), Gaussian process regression, linear classification analysis, a K-nearest neighbor (K-NN), a perceptron, a radial basis function network, a support vector machine (SVM), and the like, but the present invention is not limited thereto.

The conversion unit 112 may express learning outcomes of the learning unit 111 in a preset language, and may convert the expressed data to a context model. For example, based on ontology, the conversion unit 112 may express the learning outcomes of the learning unit 111 in a semantic web rule language (SWRL). However, the conversion unit is not limited thereto. For instance, the learning outcomes of the learning unit 111 may be expressed in a resource description framework (RDF), a web ontology language (OWL), N3, a rule markup language (RuleML), a prolog, or the like in accordance with performance and application of a system.

When the learning unit 111 recognizes a specific pattern based on the result obtained by learning the input data, the context-model creating unit 110 may further include an information requesting unit (not shown) to request context information about the input data used in the learning from a user.

For example, a user may be walking and input data may be an acceleration sensor value. In response, the learning unit 111 may recognize a specific pattern by learning the acceleration sensor value. Next, the information requesting unit (not shown) may request context information of the acceleration sensory data used in the learning from a user, and the user may enter context information indicating that the user is walking. Therefore, the specific pattern of the acceleration sensory data may be recognized when the user is walking.

The context reasoning unit 120 may update a previously stored context model based on the converted context model, and may infer a context using the input data and the updated context model. To perform these functions, the context reasoning unit 120 may include a context-model storage unit 121, a context-model updating unit 122, and a reasoning engine 123.

The context-model storage unit 121 may store a context model. For example, the context model may be an ontology-based model, but the context model is not limited thereto. That is, the context model may be a key-value model, a markup scheme model, an object oriented model, a logic-based model, or the like in accordance with performance or application of a system.

The context-model updating unit 122 may receive the context model from the conversion unit 112, and update a context model previously stored in the context-model storage unit 121. That is, the context-model updating unit 122 may combine the context model received from the conversion unit 112 and the context model previously stored in the context-model storage unit 121, update the previously stored context model, and store the updated context model in the context-model storage unit 121.

The reasoning engine 123 may infer a context of a user using the input data based on the updated context model.

According to an additional embodiment of the present disclosure, the context-aware apparatus 100 further include a context-model input unit 130 to receive a context model from the outside. For example, the context-model input unit 130 may receive a context model that is not stored in the context-model storage unit 121 from the outside, and store the received context model in the context-model storage unit 121.

FIGS. 2A and 2B are diagrams illustrating a process of updating a context model by the context-aware apparatus 100 of FIG. 1.

In this example, a context model 1 (210) is a context model that is previously stored in the context reasoning unit 120, a context model 2 (220) is a context model that is created by learning the input data in the context-model creating unit 110, and a context model 3 (230) is a context model that is updated by combining the context model 1 (210) and the context model 2 (220). In this example, it is assumed that the context model 3 (230) is required in order to infer a context of a user using input data.

The input data is input to the context-model creating unit 110 and the context reasoning unit 120 as an input. In response, the context reasoning unit 120 attempts to infer the context of the user using the input data based on the context model 1 (210) at preset reasoning intervals, but does not store the context model 3 (230) for this inferring, and therefore may fail in inferring the context.

Meanwhile, the context-model creating unit 110 may learn the input data for a preset learning period, express learning outcomes in an SWRL to create the context model 2 (220), and transmit the created context model 2 (220) to the context reasoning unit 120.

The context reasoning unit 120 may receive the context model 2 (220) from the context-model creating unit 110, and combine the received context model 2 (220) and the context model 1 (210) to create the updated context model 3 (230).

The context reasoning unit 120 may infer the context of the user using input data after updating the context model and the context model 3 (230). That is, when not storing the context model for inferring the context of the user using the input data, the context-aware apparatus 100 may combine the context model created through learning and the previously stored context model to update the context mode, thereby appropriately inferring the context of the user.

FIGS. 3A and 3B are diagrams illustrating an example of a context model created by the context-model creating unit 110 of FIG. 1.

FIG. 3A illustrates learning outcomes obtained by learning input data in the learning unit 111. FIG. 3B illustrates an example in which learning outcomes of the learning unit 111 are expressed in an SWRL.

Referring to FIGS. 3A and 3B, when input data may be expressed as ‘O’ or ‘X’ in a two-dimensional manner.

The learning unit 111 may mechanically learn the input data for a preset learning period, and may calculate an optimized boundary line for distinguishing the input data. The term “mechanically” refers to the automatic nature of the learning without additional input.

That is, as the result of the machine learning, f=ΣWᵢ*Xᵢ that is equation of the boundary line may be calculated.

FIG. 3A illustrates an example in which the result of the machine learning is represented in the form of a linear function constituted of input data values and coefficients.

Next, f=ΣWᵢ*Xᵢ that is the learning outcomes may be expressed in a preset language and converted into a context model.

FIG. 3B illustrates an example in which f=ΣWᵢ*Xᵢ that is the learning outcomes is expressed in an SWRL.

FIG. 4 is a diagram illustrating an example in which the context-aware apparatus 100 of FIG. 1 is applied to a terminal.

For illustrative purposes, it may be assumed that a context model indicating ‘increase the volume of the terminal when a user runs’ is stored in the context-model storage unit 121, and sensing data of an acceleration sensor of the terminal is received as an input of the context-aware apparatus 100.

In addition, it may be assumed that a context model for inferring whether the user runs or walks only using an acceleration sensor value is not stored in the context-aware apparatus 100.

Referring to FIG. 4 in such an example, the learning unit 111 receives sensing data of the acceleration sensor, learns the received sensing data for a learning period, and transmits the learning outcomes to the conversion unit 112.

The conversion unit 112 receives the learning outcomes, and expresses the received learning outcomes in a preset language to create a context model. For example, the learning outcomes may be expressed in an SWRL. However, the preset language is not limited thereto. For instance, the learning outcomes may be expressed in RDF, OWL, N3, RuleML, a prolog, or the like in accordance with performance or application of a system.

The context-model updating unit 122 combines the context model created in the conversion unit 112 and a context model previously stored in the context-model storage unit 121, updates the context model previously stored in the context-model storage unit 121, and stores the updated context model in the context-model storage unit 121.

The reasoning engine 123 receives the sensing data of the acceleration sensor after the context model is updated, infers whether the user is running or walking based on the updated context model, and provides, to the terminal, the reasoning result indicating a context in which the volume of the terminal is required to be increased in response to the inference that the user is running. Thus, when the user is running, the terminal may increase the volume of sound output by the terminal. Thus, the volume may be automatically adjusted without a manual input from the user.

FIG. 5 illustrates another example in which the context-aware apparatus 100 of FIG. 1 is applied to a terminal 500. In this example, the terminal is a phone. However, the context-aware apparatus 100 is not limited thereto, and may be other mobile terminals or terminals such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein.

In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

Referring to FIG. 5, the terminal 500 includes a camera 511, a sound opening 512 for a microphone and an amplifier therein, a port 513 for an earphone 514, an acceleration sensor 516, a GPS module 517 and a processing unit 518. In this example, a context reasoning unit may be included as a part of the processing unit 518. The context reasoning unit may receive an learn input data from various sensors, including the acceleration sensor 516, a camera 511, a microphone, and a GPS module 517. In this example, the context reasoning unit may infer the context, such as whether the user is walking or running, based on the acceleration sensory data received through the acceleration sensor 516. The sound output through the sound port 513 may be adjusted based on the context, and delivered to a user via an earphone 514.

The terminal 500 may also include a context-model input unit to receive a context model from the outside, or/and a context-model creating unit.

FIG. 6 is a flowchart illustrating a context-aware method according to another embodiment.

Referring to FIG. 6, in operation 610, the context-aware method according to one embodiment involves receiving input data. In this instance, the input data may include sensing data collected from at least one sensor or external data of the context-aware apparatus. Here, the sensor may include a GPS module, a proximity sensor, a motion sensor, an illuminance sensor, a gyro sensor, an acceleration sensor, a temperature sensor, a pressure sensor, and the like, and the external data of the context-aware apparatus may include SNS data, linked data, web data, and the like.

Next, in operation 620, the context-aware method involves learning the input data for a preset learning period. For example, as a learning method, a machine learning algorithm may be used such as an artificial neural network, a decision tree, GA, GP, Gaussian process regression, linear classification analysis, K-NN, a perceptron, a radial basis function network, SVM, or the like.

Next, in operation 630, the context-aware method involves expressing the learning outcomes in a preset language to create a context model. For example, the learning outcomes may be expressed in an SWRL. However, the preset language that may be used is not limited thereto. That is, the learning outcomes may be expressed in RDF, OWL, N3, RuleML, a prolog, or the like in accordance with performance or application of a system.

Next, in operation 640, the context-aware method involves the created context model and a previously stored context model to update the previously stored context model.

Next, in operation 650, the context-aware method involves inferring a context of a user using the input data based on the updated context model.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A context-aware apparatus comprising:
a context-model creating unit configured to create a context model based on input data; and
a context reasoning unit configured to update a previously stored context model in a memory storage based on the created context model, and to infer a context using the updated context model and the input data.

2. The context-aware apparatus of claim 1, wherein the previously stored context model comprises a key-value model, a markup scheme model, an object oriented model, a logic-based model, or an ontology-based model.

3. The context-aware apparatus of claim 1, wherein the context-model creating unit comprises a learning unit configured to learn the input data, and a conversion unit configured to convert learning outcomes of the learning unit into the context model by expressing the learning outcomes in a preset language.

4. The context-aware apparatus of claim 3, wherein the learning unit is configured to mechanically learn the input data for a preset learning period.

5. The context-aware apparatus of claim 3, wherein the preset language comprises a resource description framework (RDF), a web ontology language (OWL), N3, a rule markup language (RuleML), a semantic web rule language (SWRL), or a prolog.

6. The context-aware apparatus of claim 1, further comprising:
a context-model input unit configured to receive the context model from outside.

7. The context-aware apparatus of claim 3, wherein the context-aware apparatus is a mobile device capable of wireless communication or network communication; and
the context-aware apparatus is configured to obtain the input data from at least one of a proximity sensor, a microphone, a motion sensor, an illuminance sensor, a gyro sensor, an acceleration sensor, a temperature sensor, and a pressure sensor of the mobile device.

8. A context-aware method comprising:
creating a context model based on input data;
updating a previously stored context model in a memory storage based on the created context model; and
inferring a context using the input data and the updated context model.

9. The context-aware method of claim 8, wherein the previously stored context model comprises a key-value model, a markup scheme model, an object oriented model, a logic-based model, or an ontology-based model.

10. The context-aware method of claim 8, wherein the creating of the context model comprises learning the input data, and converting learning outcomes of the learning of the input data into the context model by expressing the learning outcomes.

11. The context-aware method of claim 10, wherein the learning of the input data comprises mechanically learning the input data for a preset learning period.

12. The context-aware method of claim 10, wherein the preset language comprises RDF, OWL, N3, RuleML, SWRL, or a prolog.

13. A non-transitory computer-readable medium storing instructions that cause a computer to perform the method of claim 8.

14. A context-aware apparatus comprising:
a context-model input unit configured to receive a context model from outside, the context model being based on learning of input data for a preset learning period;
and
a context reasoning unit configured to update a previously stored context model in a memory storage based on the received context model, and to infer a context using the updated context model and the input data.

15. The context-aware apparatus of claim 14, wherein the input data is obtained from a sensor comprising at least one of a proximity sensor, a microphone, a motion sensor, an illuminance sensor, a gyro sensor, an acceleration sensor, a temperature sensor, and a pressure sensor of a mobile device.
